(19) United States
(12) Patent Application Publication
(10) Pub. No.: US 2012/0046992 A1
(43) Pub. Date: Feb. 23, 2012

(54) ENTERPRISE-TO-MARKET NETWORK ANALYSIS FOR SALES ENABLEMENT AND RELATIONSHIP BUILDING

(75) Inventors: Jianying Hu, Bronx, NY (US); Aleksandra Mosjilovic, New York, NY (US); Vikas Sindhwani, Hawthorne, NY (US)

(73) Assignee: INTERNATIONAL BUSINESS MACHINES CORPORATION, Armonk, NY (US)

(21) Appl. No.: 12/861,168

(22) Filed: Aug. 23, 2010

(51) Int. Cl. G06Q 10/00; G06Q 99/00

(52) U.S. Cl. 705/7.29; 705/319

(57) ABSTRACT

There are provided a system, a method and a computer program product for increasing of productivity of sales force in a first entity. The system locates or constructs at least one enterprise social network in the first entity. The system constructs at least one market social network. The system creates at least one connection between the enterprise social network and the market social network. Sales representative in the first entity expands new sales operations and/or identify new markets via the connected social networks.

### BACKGROUND

The present application generally relates to an enterprise management. More particularly, the present application relates to improving sales operations, strategy and productivity in an entity.

An entity includes, but is not limited to: a private organization (e.g., bank, private company, etc.), a public organization (e.g., public school, government, police/fire department, post office, etc.), non-profit organization, a person, a product, a transaction, etc. Sales productivity and effectiveness are among critical issues for most companies, especially those with large sales force (e.g., more than 1,000 sales representatives) and client-oriented organizations (e.g., consulting companies, insurance companies, software and hardware manufacturers, etc.). Improving a productivity of a large sales force can be an effective operational strategy to drive revenue growth and manage bottom-line expenses. In challenging economic climate or in the times of fierce market competition, sales people, sales managers and business executives are often feeling a pressure to “do more sales with fewer expenses.” Thus, companies are hiring consultants, establishing task-forces and often setting up entire departments to deal with sales force productivity issues.

Improving productivity and driving sales growth requires that sales professionals be provided with leading edge tools to identify better leads, close more deals, close deals faster and interact with clients more effectively. Hiring hard-working sales people is the first step in increasing sales force productivity. However it has been increasingly recognized that realizing a true potential of a large sales force requires that sales representative, their managers and business leaders have relevant and timely information about clients, marketplaces, and products that are being sold. As a result, enterprises are investing in the development of computer-based platforms, solutions and/or methodologies to improve the sales force productivity. For example, during the past decade, there have been developments of customer relationship management (CRM) systems, which provide integration and management of data relevant to completing marketing and sales processes. There also have been sales force automation systems, which enable sales executives to balance sales representatives against identified opportunities. Such systems improve an overall efficiency of a sales process, e.g., by integrating relevant sales force data and by automating some of the sales processes. However, once the integration and automation steps are completed, major advances in the sales force productivity will require not only an access to the integrated data, but also to an ability to derive new information and insights by applying predictive and prescriptive analytics on such integrated data. An example of analytics used to enrich the sales process is a client segmentation methodology, which utilize a number of client characteristics (e.g. firmographics, client financial performance, previous purchases, client satisfaction scores, etc.) to label client accounts into “good vs. bad”, “grow vs. maintain vs. de-invest”, “core vs. cash”, etc. An improvement over the client segmentation methodology is a client propensity modeling. Based on examples of clients who made and did not make certain purchases in the past and based on the aforementioned client characteristics, the client propensity modeling develops a classifier or a predictive model to estimate a likelihood of a new company “X” buying a product “Y” in the future. Another type of predictive methodology often used to generate sales leads is a market basket analysis where predictive analytics is used to identify products that are commonly bought together or that follow a certain purchasing sequence, and then the predictive analytics generate recommendations to sales representatives as to which clients might buy additional products or services in the future.

However, most of the approaches mentioned so far create insights using predominantly information about the client, e.g., firmographics data (i.e., data representing of characteristics of an organization), client financial metrics, estimated wallet, or past transactions. On the other hand, one of the key characteristics of the sales process is that it is dynamical and relationship driven, which is not accounted for in any of these approaches. In addition to having good information about the client, a sales success also depends on networking and relationship building. Most successful sales representatives are often those who have “rich” personal and professional networks, or who have an ability to gather information, resources or individuals relevant to the sales process. For example, sales representatives who are better connected tend to make better sales. Sales representatives who know more about a certain product or who are able to reach out to product technical experts tend to make better sales of that product. Sales representatives who know how to reach out to their colleagues who worked with clients and who leverage their experiences tend to be more effective in dealing with those clients. Equally important to the success of the sales process are the relationships and connections that exist among client companies in a marketplace. Companies that have partnerships, that have joint ventures, and/or that have a significant degree of interactions could easily share a same “mindset” with respect to a certain product, or vendor. Senior executives often move from one corporation to another and therefore influence the “mindset” with respect to a certain product or vendor. Finally, relationships between sales representatives and clients also carry important additional information that can be used to make the sales process more effective/efficient and improve its outcome. For example, sales representatives who have more experiences selling to a certain client (company) are typically more effective in selling to that client again. Sales representatives who have good networks and solid personal relationships with decision-makers at a client company (e.g. worked together, went to school together, board/club memberships etc.) might be more effective in making a sale with that client.

In other words, social relationships and experiences play an important role in the sales process, yet none of the aforementioned approaches incorporate social information in arriving at a final decision or recommendation. On the other hand, there have been a lot of activities in a field of social networking and social media, e.g. Facebook™, Linkedin®, internal corporate social networks, etc. However, all these social networking and social media have been used as a vehicle for connecting people, staying in touch, and getting better visibility into communities that share similar interests/characteristics without being predictive/prescriptive and without an ability to generate insights (automatically) that can be leveraged to drive sales strategy and enablement.

### SUMMARY OF THE INVENTION

The present disclosure describes a system, method and computer program product for increasing the productivity of sales force in an entity, e.g., by deriving new insights and recommendations on clients, markets, products, sales operation and sales strategy.

In one embodiment, there is provided a system for increasing a productivity of sales force in a first entity. The system comprises a memory device and a processor being connected to the memory device. The processor locates or constructs at least one enterprise social network in the first entity. The processor constructs at least one market social network. The processor creates at least one connection between the enterprise social network and the market social network. The processor accesses the enterprise social network, the market social network and the created connection to determine a strategy for potential sales operations.

In a further embodiment, the market social network is a social network that captures at least one relationship among other entities, and the connection includes at least one edge between the enterprise social network and the market social network.

In a further embodiment, to construct the market social network, the processor indexes data of the other entities. The processor filters items in the indexed data relevant to the first entity. The processor extracts from the filtered items to obtain entity names in the other entities. The processor applies a natural language processing technique to infer the relationship between the obtained entity names and the first entity. The processor creates nodes representing the obtained entity names. The processor creates edges connecting the obtained entity names and representing the relationship.

### BRIEF DESCRIPTION OF THE DRAWINGS

The accompanying drawings are included to provide a further understanding of the present invention, and are incorporated in and constitute a part of this specification.

FIG. 1 illustrates a flow chart depicting of method steps for increasing of productivity of sales force in an entity in one embodiment.

FIG. 2 illustrates a flow chart depicting of method steps for constructing the market social network in one embodiment.

FIG. 3 illustrates an exemplary enterprise social network, an exemplary market social network and exemplary their connections in one embodiment.

FIG. 4 illustrates an exemplary hardware configuration for implementing the flow chart depicted in FIGS. 1-2 in one embodiment.

### DETAILED DESCRIPTION

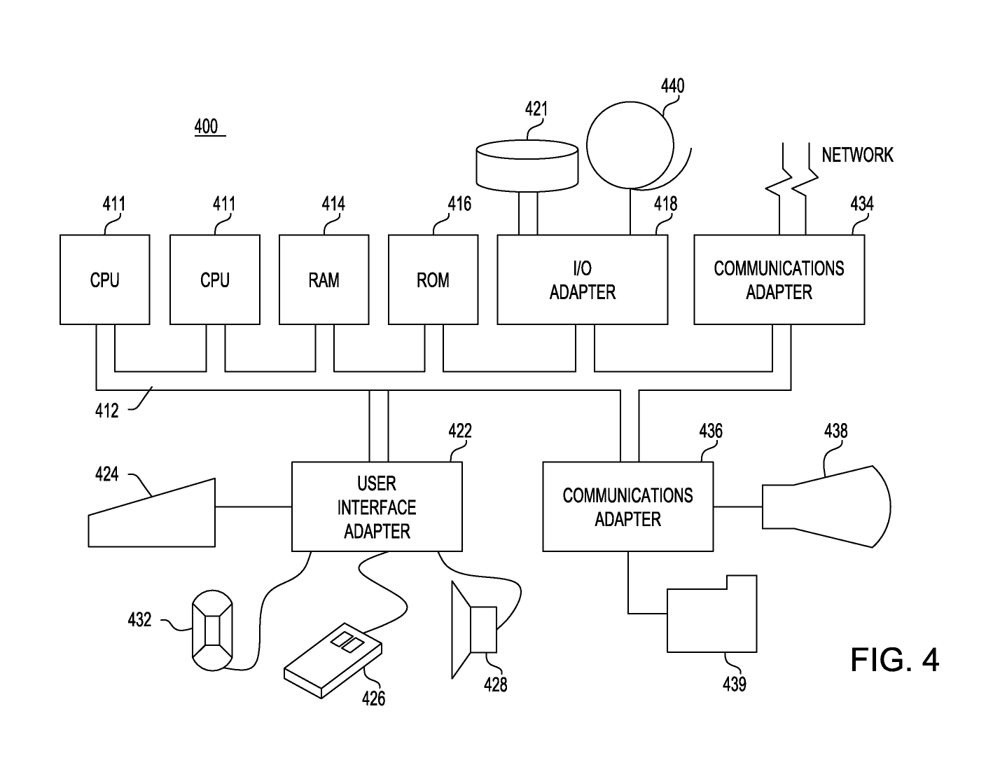

This present disclosure describes a methodology to capture, quantify and/or derive insight from social relationships or any other connections between various entities and use the insight for sales enablement. The methodology describes, without limitation: (1) constructing a social network of market relationships, (2) utilizing existing social networks (e.g. “my friends in Facebook”, or “my connections in Linkedin,” etc.), as well as any other potential interactions between users (e.g. employees worked on the same project before, published a paper or a patent together, exchanged emails, etc.) to capture the connections between the users and create a network of enterprise relationships, and (3) utilizing information on sales and marketing transactions, social relationships, etc, to construct connections between the social network of market relationships and social network of enterprise relationships. In order to construct the market social network, a computing system (e.g., a computing system 400 in FIG. 4) integrates diverse data from multiple sources (e.g., multiple company web sites, etc.), data about markets, news, and/or events, and derives relationships among the companies.

An automated methodology for a social network analysis, ranking and/or search may be used as an aid in one or more of: (1) Market Opportunity Identification (“which part of the market requires a new/more coverage”); (2) Measuring Influence (“how should the market be influenced by discovering who the key market players are”, or “which segments of the market are influenced by competitors”); (3) Action Recommendation (“how should better coverage be achieved through optimal sales-to-market connections”); (4) Client Reach (“identifying paths that lead sales representatives to target clients with a propensity to be a customer”); (5) Expertise Location (“who sold this product before”), etc. A social network analysis refers to a mapping and/or measuring of relationships between people, teams, organizations, and any other entities. A node in the social network represents a person or a team while an edge represents a relationship between nodes. A ranking technique and a search technique may be used to improve query results associated with the social network. Sergey Brin, et al, “The PageRank Citation Ranking: Bringing Order to the Web”, http://ilpubs.stanford.edu:8090/422/1/1999-66.pdf, wholly incorporated by reference as if set forth herein, describes a ranking technique in detail. Tarjan, “Two Streamlined Depth-First Search Algorithms,” 1986, Polish Mathematical Society, wholly incorporated by reference as if set forth herein, describes a search technique in detail.

In one embodiment, the present invention may be implemented manually. A sales representative interested in approaching a client might browse or attempt to search a social network (e.g., Facebook™, etc.) to find a decision-making executive at the client company. Once the sales representative identifies the executive, the sales representative can search the executive's social network for a potential mutual contact (e.g., “mutual friends” in Facebook™, etc.). The sale representative can also attempt to search among his sales colleagues to identify sales representative(s) who might have dealt with the client (e.g., a company where the executive works for) in the past. Therefore, an ability to automatically derive such insights from existing social relationships or connectivity data may be invaluable in formulating a sales strategy.

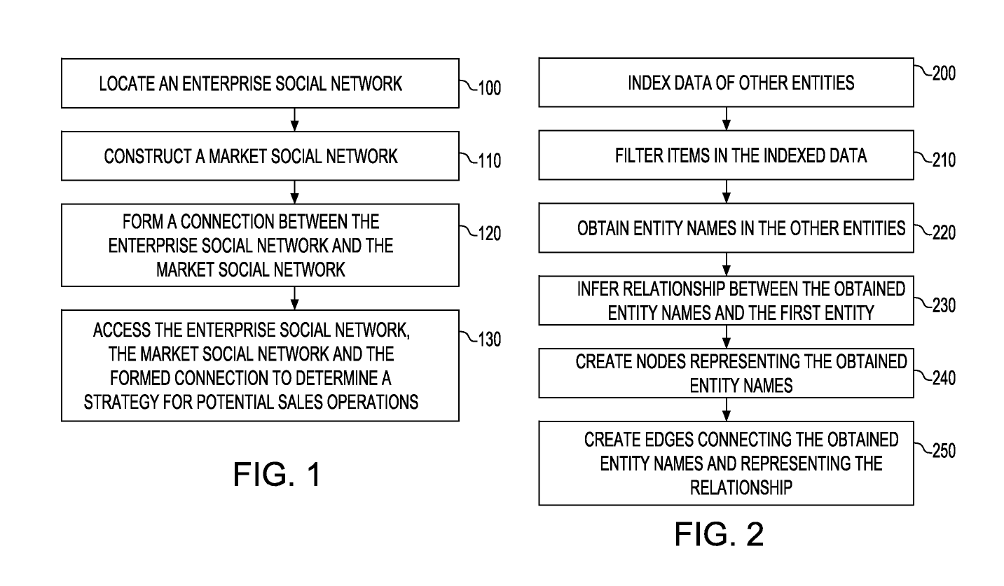

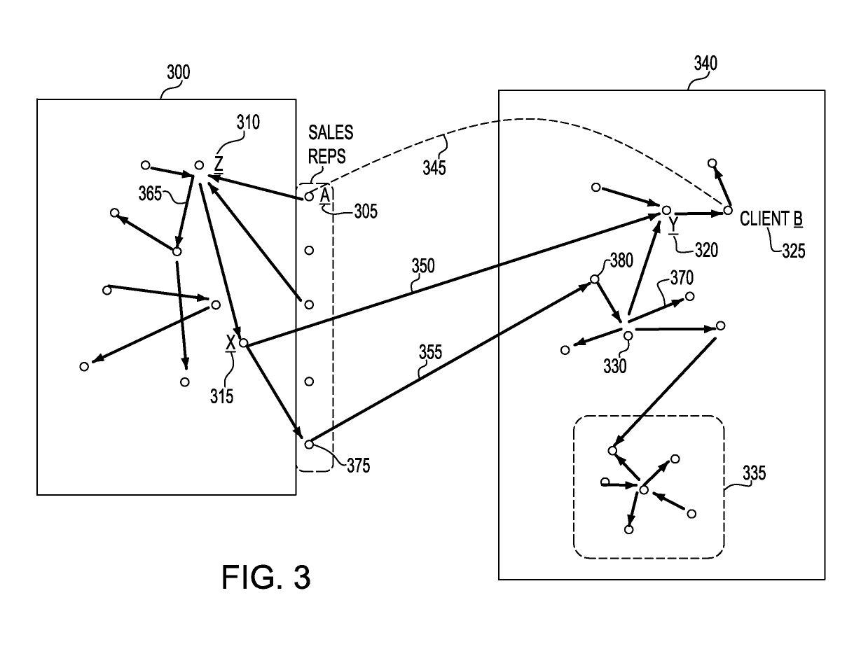

In one embodiment, the present invention is implemented in the computing system that runs method steps depicted in FIG. 1. FIG. 1 illustrates a flow chart depicting method steps for increasing of productivity of sales force in a first entity. At step 100, the computing system locates (i.e., accesses) at least one enterprise social network (e.g., IBM® SmallBlue, IBM®Beehive, IBM® Sametime, IBM® Lotus® connections, etc.) in the first entity. An enterprise social network (e.g., a network 300 in FIG. 3) is a social network designed to capture and leverage connections among people in the first entity. The enterprise social network includes nodes (e.g., a node 310 in FIG. 3) that represent the people in the first entity and edges (e.g., an edge 365 in FIG. 3) that represent relationships (e.g., “an employee reports to another employee”) between the people or that represent data (e.g., a hierarchy in the entity) pertaining to the first entity.

In another embodiment, at step 100 in FIG. 1, the computing system constructs an enterprise social network, e.g., by using social and/or business relationships between people in the first entity. In another embodiment, the computing system expands an existing enterprise social network, e.g., by using new social and/or business relationships between people in the first entity.

In a further embodiment, in a purpose of determining and/or implementing sales strategies of the first entity, the computing system categorizes nodes in the enterprise social network into several types of categories and assigns each node a different weight representing an importance of the category. For example, one category is sales representatives (SR), followed by service delivery subject matter experts (SMEs), and followed by others. Each node in the enterprise social network may include at least one attribute, e.g., CV information. Similarly, the computing system may categorize edges (i.e., relationships among different employees) into different types, e.g., according to prior project teams, prior sales history, a hierarchical structure of an organization of the employees, a causal interaction, etc. The computing system may assign each edge with a different weight, e.g., according to prior project teams, prior sales history, a hierarchical structure of an organization of the employees, a causal interaction, etc. For example, each prior sale may have a different weight based on sales amount. An edge representing the highest amount of sales may have the highest weight (e.g., an integer number “10”). An edge representing the lowest amount of sales may have the lowest weight (e.g., an integer number “1”). The edges in the enterprise social network are called intra-enterprise edges. The computing system obtains the edges (i.e., the relationships among employees) from diverse data sources, e.g., a corporation ERM (Enterprise Risk Management) systems which include sales and project delivery records, formal reporting structures, online communities, emails, instant messaging exchanges, etc. A user (e.g., a sales representative of or associated with the first entity) may access these intra-enterprise edges, e.g., by sending and/or receiving queries to a database that stores the enterprise social network.

Returning to FIG. 1, at step 110, the computing system constructs at least one market social network (e.g., a social network 340 in FIG. 3), e.g., by running method steps depicted in FIG. 2. A market social network is a social network that captures at least one relationship (e.g., partnership, etc.) among other entities (i.e., entities other than the first entity). A node (e.g., a node 320 in FIG. 3) in the market social network represents an entity. A market edge (e.g., an edge 370 in FIG. 3) represents a relationship between different entities. The computing system determines the relationship, e.g., from a product sales history, a prior/current partnership, an open web site (i.e., a web site opened to the public; e.g., www.factiva.com), etc. For example, if a company “K” sold its products to another company “R” within last month/year, there may a market edge representing the sale of those products between a node representing the company “K” and a node representing the company “R”. The computing system can also build the edges, e.g., from diverse sources, e.g., Market Intelligence channels, the open web site (e.g., www.factiva.com, etc.), a company webs site, a business news web site, etc. An attribute for each node in the market social network includes, but is not limited to: Firmographics data (i.e., characteristics of an organization) and key words extracted from entity web pages, etc. An attribute for each edge in the market social network includes, but is not limited to: a product type being sold between two different entities, a source of the edge (i.e., where the corresponding relationship was obtained), etc. The computing system may further categorize edges between different nodes (i.e., different entities) into one or more of: (1) business transactions: who bought what from whom; (2) business alliances: joint ventures, partnerships, etc.; (3) officer relations: e.g., company X's CIO Jane is on a board of company Y, company A's CTO John used to be company B's CIO, etc.

FIG. 2 illustrates a flow chart depicting method steps for constructing a market social network in one embodiment. At step 200, the computing system indexes data (e.g., web pages, stock information, news articles, news feed, research information, etc.) of the other entities (i.e., entities other than the first entity). At step 210, the computing system filters items in the indexed data to obtain information of the first entity, e.g., by classifying the indexed data. Thorsten Joachims, “Text Categorization with Support Vector Machines with Many Relevant Features”, LS-8 Report 23, April 1998, wholly incorporated by reference as if set forth herein, describes a text classification technique in detail.

At step 220, the computing system runs a named entity extractor to obtain entity names (e.g., company names, officer names, etc.) in the other entities. A named entity extractor accesses and extracts information to locate elements (e.g., names of organizations, etc.) in a text. Etzioni, “Unsupervised Named-Entity Extraction from the Web: An Experimental Study,” February 2005, University of Washington, wholly incorporated by reference as if set forth herein, describes an exemplary named entity extractor in detail. At step 230, the computing system applies a natural language processing (NLP) technique to infer a relationship between the obtained entity names in the other entities and the filtered items about the first entity. The relationship includes, but is not limited to, a prior sales history, a prior/current partnership, a board membership, etc. In one embodiment, this inference is performed, e.g., by constructing a dictionary of phrases and inferring an edge if a phrase is found together with associated named entities in a text. In one embodiment, NLP techniques may be further applied to extract more information, e.g., a type of the partnership, a sales amounts, etc. At step 240, the computing system creates nodes in the market social network, where the nodes represent the obtained entity names and/or the filtered items. At step 250, the computing system creates edges that connect the obtained entity names and/or represent the relationship.

Returning to FIG. 1, at step 120, the computing system creates at least one connection (e.g., connections 350-355 in FIG. 3) between the enterprise social network and the market social network. An exemplary connection may include, but is not limited to: a sale transaction edge, a delivery transaction edge and an association edge described below. In one embodiment, a connection includes at least one edge between the enterprise social network and the market social network, and serves as a conjunction between an enterprise workforce and its marketplace. Any node within the enterprise social network can be directly connected to any node in the market social network. In one embodiment, the computing system categorizes edge(s) in the connection into at least three categories: (1) a sales transaction edge that represents a particular sales representative sold a particular product to a particular client; (2) a delivery transaction edge that represents a particular subject matter expert provided a particular service to a particular client; and (3) an association edge that represents an employment history (e.g., an employee “A” used to work for company “X”), a board membership (e.g., an employee “B” sits on a board of company “Y”), etc. The edges in the connection are called enterprise-to-market edges. At step 130, the computing system uses the enterprise social network, the market social network and/or the created connection to determine a strategy for a potential sales operations including, without limitation, expanding a sales operation, identifying a new market, providing a guidance to the sales force.

In one embodiment, once the computing system constructs these three components (e.g., the enterprise social network, the market social network, the connection(s)), the computing system can identify multiple paths (e.g., a first path: “A” 305→“Z” 310→“X” 315→a connection 350→“Y” 320→“B” 325, a second path: “A” 305→“Z” 310→“X” 315→a sales representative 375→a connection 355→a node 380→a node 330→“Y” 320→“B” 325) connecting any node in the enterprise social network to any node in the market social network. The path between any two nodes may potentially involve all three types of edges including intra-enterprise edges, market edges, and enterprise-to-market edges. A computing system can evaluate a strength of a path, e.g., measuring a length of the path and/or measuring strength of each edge in the path. The computing system measures a length of a path, e.g., by counting the number of hops, nodes, and/or edges. Alternatively, an edge in the enterprise social network can be weighted, for example, by the number of email messages between two individuals. Likewise, an edge in the market social network can be weighted, for example, by the number of co-occurrences of the two entities in web pages. The enterprise-to-market edges can be weighted by different factors, e.g., historical revenue generated for a particular enterprise by serving a particular client.

In a further embodiment, the computing system identifies a “strongest” path (e.g., the shortest path) among the multiple paths. The computing system finds the strongest path, e.g., by running known Dijkstra's shortest path algorithm that identify a path between two nodes such that a sum of weights of edges is minimized. Then, computing system allocates sales resources (e.g., sales representatives, etc.) of the first entity to at least one node in the market social network included in the highest strength path. To optimally allocate sales resources, it is intuitively important for sales personnel or representatives to reach out to well-connected nodes (e.g., nodes in the market social network on the strongest path) early. In other words, important nodes (e.g., nodes in the market social network on the strongest path) should be approached first so that the market identified in the highest strength path has a chance of being covered quickly.

In a further embodiment, the computing system provides information of how should the first entity penetrate a new market segment, e.g., utilizing PageRank™ technique or HITS algorithm, etc. While relevance ranking encodes degrees of approachability with respect to existing relationships, the ranking may not provide a measure of a community value (e.g., how well-connected and influential a node is). To determine a way to penetrate a new market segment, the computing system uses one or more of: PageRank™ technique, Flow Betweenness, and HITS (Hyperlink Induced Topic Search) algorithm. PageRank™ was popularized in the context of ranking web pages according to a probability that a random surfer following network edges would arrive at a specific node. Sergey Brin, et al, “The PageRank Citation Ranking: Bringing Order to the Web”, http://ilpubs.stanford.edu:8090/422/1/1999-66.pdf, wholly incorporated by reference as if set forth herein, describes a ranking technique in detail. Flow Betweenness is a measure of importance of connectedness of a node measured in terms of a fraction of all shortest paths between two nodes in a graph. In other words, Flow Betweenness refers to a degree that a particular node contributes to a sum of maximum flows between all pairs of nodes. The HITS algorithm is another graph based technique that assigns a hub and an authority measure to each node via a recursive definition that an authority ranking of a node depends on hub rankings of nodes pointing to it, and vice-versa. In other words, HITS algorithm determines two values for a web page: (1) its authority, which estimates a value of the content of the web page; and (2) its hub value, which estimates a value of its links to other web pages. In a web page ranking context, good hubs are those web pages that link to web pages that have good contents. In a market social network, if directed edges represent buying-selling relationships, then the hubs and authority values provide measures of importance as a buyer and as a seller respectively. Jon M. Kleinberg, “Authoritative Sources in a Hyperlinked Environment”, Proceedings of ACM-SIAM Symposium on Discrete Algorithms, 1998, wholly incorporated by reference as if set forth herein, describes the HITS algorithm in detail.

In a further embodiment, the computing system provides guidance to sales representatives in the first entity, e.g., by teaching them how to approach a new client in the market social network based on the connection (e.g., connections 350-355 in FIG. 3). FIG. 3 illustrates that how a sales representative “A” 305 can approach a new potential client “B” 325. Via a network analysis, the computing system may identify the strongest path (e.g., the shortest path) connecting A and B, e.g., via internal contacts “Z” 310 and “X” 315 and an external contact “Y” 320. A relationship building is critical in a success of business deals. Identifying an optimal chain of contacts with which to approach a new client adds a significant value to sales operations in the first entity. Thus, the computing system provides a detailed plan (e.g., “A” 305→“Z” 310→“X” 315→“Y” 320”→“B” 325) to a sales representative on how to approach a new client, e.g., by identifying the shortest path between “A” 305 and “B” 325. Using internal employee databases and transaction records, the sales representative can be provided with information on whom to approach and in what context. Conversely, the sales representative may also query, e.g., by using SQL language, a database in the computing system to find at least one client (e.g., a node 330 in FIG. 3) with sufficient authority (i.e., a person in an organization who can authorize a purchase of a product) and to find at least one path to the authority that is reachable via social network(s).

In a further embodiment, the computing system analyzes the connection between the enterprise social network and the market social network in order to perform one or more of: (a) expand a sales operation; and (b) identify a new market (e.g., a new market 335 in FIG. 3). The computing system may identify a new market, e.g., by identifying untouched nodes of the market social network that can be reached via the connections (e.g., connections 350-355 in FIG. 3). The market social network may be viewed as a partially labeled graph where nodes that are currently “touched” by the first entity may receive “queries” from a user via the computing system. The computing system may rank untouched nodes according to these queries. For example, companies that can be reached via the connections from nodes that have an existing relationship to the first entity is ranked higher than those that are further away as the companies are good candidates for expansion of sales operations. In one embodiment, the computing system implements the node ranking as follows: (1) assign a positive ranking score (e.g., integer number “1”) to a node having an existing relationship to the first entity, e.g., according to a table (not shown) describing each score for each relationship, (2) set remaining nodes to have zero value, (3) all nodes then spread their score to their neighbors via the market social network, e.g., if a node “P” having “0” score value is connected to a node “T” having “1” score value and to a node “H” having “4” score value, the score value “1” of the node “T” is assigned to the node “P” by choosing the lowest score value of node P's neighbors. These steps (1)-(3) are repeated until a convergence, i.e., until all nodes in the market social network have non-zero scores. Converged values are used for ranking. In another embodiment, it is possible to formulate this ranking implementation in terms of solving sparse linear systems where a network is represented as a sparse matrix.

It is also useful to identify not just easy-to-reach untouched nodes in the market social network, but also clusters of far-away nodes (e.g., a group of nodes 335 in FIG. 3) as the far-away nodes identify market segments that are relatively underexplored by the first entity. The computing system may identify such far-away nodes of companies, e.g., by using node clustering techniques. M. E. J. Newman, “Fast algorithm for detecting community structure in networks”, Physical Review E 69, 066133, June, 2004, wholly incorporated by reference as if set forth herein, describes node clustering techniques in detail. Once the computing system clusters the market social network, the computing system assign a score to each cluster, e.g., by aggregating ranking scores of nodes in the cluster. The lowest scored clusters may represent segments of potentially new markets because the first entity can contact or explore nodes in the lowest scored clusters, e.g., via the strongest path found above.

FIG. 4 illustrates an exemplary hardware configuration of a computing system 400 running and/or implementing the method steps in FIGS. 1-2. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. In a further embodiment, the computing system analyzes properties of the enterprise and market social networks to build features for predictive models of a propensity for a customer to buy a product, or to close a deal in a particular period of time.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for increasing productivity of sales force in a first entity, the method comprising:
locating or constructing at least one enterprise social network in the first entity;
constructing at least one market social network;
creating at least one connection between the enterprise social network and the market social network; and
accessing the enterprise social network, the market social network and the created connection to determine a strategy for potential sales operations,
wherein a computing system including at least one processor and memory device performs one or more of: the locating, the constructing, the creating, and the accessing.

2. The method according to claim 1, wherein the enterprise social network is a social network designed to capture and leverage connections among people in the first entity.

3. The method according to claim 2, wherein the enterprise social network includes nodes representing the people in the first entity and edges representing relationships between the people or representing data pertaining to the first entity.

4. The method according to claim 1, wherein the market social network is a social network that is adapted to capture at least one relationship among other entities, and the connection includes at least one edge between the enterprise social network and the market social network.

5. The method according to claim 4, wherein the constructing the market social network comprises steps of:
indexing data of the other entities;
filtering items in the indexed data relevant to the first entity;
extracting from the filtered items to obtain entity names in the other entities;
applying a natural language processing to infer the relationship between the obtained entity names and the first entity;
creating nodes representing the obtained entity names; and
creating edges connecting the obtained entity names and representing the relationship.

6. The method according to claim 4, wherein the edge is categorized one of: a sale transaction edge representing that a particular sales representative sold a particular product to a particular client, a delivery transaction edge representing that a particular subject matter expert provided a particular type of service to a particular client, and an association edge representing an employment history or board membership.

7. The method according to claim 1, further comprising:
identifying at least one path between a node in the enterprise social network and a node in the market social network; and
evaluating a strength of the path.

8. The method according to claim 7, wherein the evaluating the strength of the path includes one or more of:
measuring a length of the path; and
measuring a strength of each edge in the path.

9. The method according to claim 8, further comprising:
identifying a strongest path;
allocating sales resources of the first entity to a node in the market social network included in the strongest path.

10. The method according to claim 1, wherein the accessing further comprises:
analyzing the created connection between the enterprise social network and the market social network to expand a sales operation or identify a new market.

11. The method according to claim 10, wherein the analyzing includes ranking nodes in the market social network.

12. The method according to claim 1, wherein the accessing further comprises:
providing a guidance to the sales force that teaches how to approach a new client in the market social network based on the created connection.

13. A system for increasing productivity of sales force in a first entity, the system comprising:
a memory device; and
a processor being connected to the memory device,
wherein the processor performs steps of:
locating or constructing at least one enterprise social network in the first entity;
constructing at least one market social network;
creating at least one connection between the enterprise social network and the market social network; and
accessing the enterprise social network, the market social network and the created connection to determine a strategy for potential sales operations.

14. The system according to claim 13, wherein the enterprise social network is a social network designed to capture and leverage connections among people in the first entity.

15. The system according to claim 14, wherein the enterprise social network includes nodes representing the people in the first entity and edges representing relationships between the people or representing data pertaining to the first entity.

16. The system according to claim 13, wherein the market social network is a social network that is adapted to capture at least one relationship among other entities, and the connection includes at least one edge between the enterprise social network and the market social network.

17. The system according to claim 16, wherein, to construct the market social network, the processor further performs steps of:
indexing data of the other entities;
filtering items in the indexed data relevant to the first entity;
extracting from the filtered items to obtain entity names in the other entities;
applying a natural language processing to infer the relationship between the obtained entity names and the first entity;
creating nodes representing the obtained entity names; and
creating edges connecting the obtained entity names and representing the relationship.

18. The system according to claim 16, wherein the edge is categorized one of: a sale transaction edge representing that a particular sales representative sold a particular product to a particular client, a delivery transaction edge representing that a particular subject matter expert provided a particular type of service to a particular client, and an association edge representing an employment history or board membership.

19. The system according to claim 13, wherein the processor further performs steps of:
identifying at least one path between a node in the enterprise social network and a node in the market social network; and
evaluating a strength of the path.

20. The system according to claim 19, wherein, to evaluate the strength of the path, the processor further performs one or more of:
measuring a length of the path; and
measuring a strength of each edge in the path.

21. The system according to claim 20, wherein the processor further performs steps of:
identifying a strongest path;
allocating sales resources of the first entity to a node in the market social network included in the strongest path.

22. The system according to claim 13, wherein the accessing further comprises:
analyzing the created connection between the enterprise social network and the market social network to expand a sales operation or identify a new market.

23. The system according to claim 22, wherein the analyzing includes ranking nodes in the market social network.

24. The system according to claim 13, wherein the accessing further comprises:
providing a guidance to the sales force that teaches how to approach a new client in the market social network based on the created connection.

25. A computer program product for increasing productivity of sales force in a first entity, the computer program product comprising a storage medium readable by a processor and storing instructions run by the processor for performing a method, the method comprising:
locating or constructing at least one enterprise social network in the first entity;
constructing at least one market social network;
creating at least one connection between the enterprise social network and the market social network; and
accessing the enterprise social network, the market social network and the created connection to determine a strategy for potential sales operations.
